(19) United States
(12) Patent Application Publication
(10) Pub. No.: US 2024/0212557 A1
(43) Pub. Date: Jun. 27, 2024

(54) VARIABLE REFRESH RATE

(71) Applicant: Texas Instruments Incorporated, Dallas, TX (US)

(72) Inventors: Aravind Lakshminarayanan, Frisco, TX (US); Jeffrey S. Farris, Flower Mound, TX (US); Daniel J Morgan, McKinney, TX (US)

(73) Assignee: Texas Instruments Incorporated, Dallas, TX (US)

(21) Appl. No.: 18/542,696

(22) Filed: Dec. 17, 2023

Related U.S. Application Data
(60) Provisional application No. 63/476,966, filed on Dec. 23, 2022.

(51) Int. Cl. G09G 3/20

(52) U.S. Cl. CPC G09G 3/2025; G09G 3/2014; G09G 2320/0252; G09G 2320/0266; G09G 2360/127; G09G 2360/128; G09G 2360/18

(57) ABSTRACT

A display controller includes a variable refresh rate circuit. The variable refresh rate circuit is configured to receive a first video frame, and provide a first dithered segment of the first video frame comprising instructions to display the first dithered segment during reception of a second video frame. The variable refresh rate circuit is also configured to, responsive to reception of the second video frame and completion of display of the first dithered segment, provide a second dithered segment of the second video frame comprising instructions to display the second dithered segment.

### CROSS-REFERENCE TO RELATED APPLICATIONS

This application claims priority to U.S. Provisional Application No. 63/476,966, filed Dec. 23, 2022, entitled “Variable Refresh Rate Method for SLMs,” which is hereby incorporated by reference in its entirety.

### BACKGROUND

Many image display systems utilize spatial light modulators (SLMs). SLMs include arrays of individually addressable and controllable pixel elements that modulate light according to input data streams corresponding to image frame pixel data. Digital micromirror devices (DMDs) are a type of SLM. A DMD has an array of micromechanical pixel elements, each having a tiny mirror that is individually addressable by an electrical signal. Depending on the state of its addressing signal, each mirror element tilts so that it either does or does not reflect light to the image plane.

Other examples of an SLM include a liquid crystal display (LCD) or a liquid crystal on silicon (LCOS) display which have individually driven pixel elements. An LCOS device includes a liquid crystal display shutter disposed between a mirror and a layer of glass. The liquid crystals are modulated to pass light, the light passed through the liquid crystal is reflected, by the mirror, through a color filter. In the various types of SLMs, displaying each frame of pixel data is accomplished by loading memory cells so that pixel elements can be simultaneously addressed.

### SUMMARY

In one example, a display controller includes a variable refresh rate circuit. The variable refresh rate circuit is configured to receive a first video frame, and provide a first dithered segment of the first video frame comprising instructions to display the first dithered segment during reception of a second video frame. The variable refresh rate circuit is also configured to, responsive to reception of the second video frame and completion of display of the first dithered segment, provide a second dithered segment of the second video frame comprising instructions to display the second dithered segment.

In another example, a method includes receiving, by a display controller, a first video frame, and providing, by the display controller, the first video frame as first, second, and third color segments to a spatial light modulator (SLM). The color segments include multiple dithered segments. The method also includes receiving, by the display controller, a second video frame while the first video frame is being displayed by the SLM, and providing, by the display controller, a dithered segment of the second video frame to the SLM responsive to receipt of the second video frame and completion of display of a dithered segment of the first video frame.

In a further example, a system includes an SLM and a display controller. The display controller includes a video input, an SLM control output, and a variable refresh rate circuit. The SLM control output is coupled to an input of the SLM. The variable refresh rate circuit is configured to receive, via the video input, a first video frame, and instruct, via the SLM control output, the SLM to display a first dithered segment of the first video frame during reception of a second video frame. The variable refresh rate circuit is also configured to, responsive to reception of the second video frame and completion of display of the first dithered segment, instruct, via the SLM control output, the SLM to display a second dithered segment of the second video frame.

### BRIEF DESCRIPTION OF THE DRAWINGS

FIG. 1 is an example timing diagram showing display of video frames with a variable refresh rate.

FIGS. 2 and 3 are block diagrams of example systems that can display video with a variable refresh rate.

FIG. 4 is a timing diagram illustrating example source and display frame timing in a system with a variable refresh rate.

FIGS. 5 and 6 are flow diagrams for methods of displaying video with a variable refresh rate.

FIG. 7 is a flow diagram for an example method of triggering generation of a dithered segment of a video frame responsive to storage of a video frame.

FIG. 8 is a timing diagram illustrating example reception of a video frame with storage in a buffer that is subdivided into multiple sub-buffers.

FIG. 9 is a flow diagram for an example method of triggering generation of a dithered segment of a video frame responsive to storage of a video frame.

FIG. 10 is a timing diagram illustrating example display frame rate adjustment based on variable refresh rate source video.

FIG. 11 is a flow diagram for a method of providing a display frame rate in a system with a variable refresh rate.

FIG. 12 is a timing diagram illustrating example source and display frame timing in a system with variable refresh rate and a modulated position spatial light modulator and/or a color wheel.

### DETAILED DESCRIPTION

In systems that include both image processing and a display, like a computer or an augmented reality headset, a host processor rendering image frames can render images at different rates based on image complexity in applications such as gaming. Sudden complex changes to image frames requires a slower render rate while simple changes can be rendered quickly. The host processor can delay generation of new frames when the content hasn't changed. Accordingly, the display receives image frames at varying rates. To accommodate the host processor's rendering of frames at different rates, the display controllers and system described herein support variable refresh rates (VRR) while exhibiting no brightness fluctuations or undesirable artifacts.

The display controllers described herein can adaptively stretch or shrink each spatial light modulator (SLM) displayed frame period to match the duration of the current source frame period from the host processor. When the frame rate is changing faster than possible sequence change, the display controller can provide a sequence that is asynchronous to the incoming frame rate. No dark times are introduced on the SLM because the SLM display frame period is adaptively adjusted to match the current source frame period. Accordingly, there are no average brightness variations per second due to the source frame rate variation. No image tears occur because complete image frames are shown in each frame before the next image frame begins to be displayed.

The display controller can cascade a series of many dithered frames to cover the duration of the source frame time, adaptively adding or removing dithered frames as needed. For example, before the next frame arrives, the display controller may just keep adding dithered frames. Each full-color dithered frame, although short in duration, displays an entire frame at full bit-depth.

This is possible via the dithering done by bit-plane dithering. Each color segment within a dithered frame displays an entire frame of that color at full bit-depth. Furthermore, a dithered segment executed within a color segment also shows an entire frame of that color at full bit-depth. With bit plane dithering the source frame rate is up-converted to the source frame rate times the number of dithered frames. For example, 60 Hz source rate ×20 dithered frames=1200 Hz display frame rate. Since a new source video frame may arrive at any random time, it arrives asynchronous to the dithered frame currently being displayed. Thus, when the source frame rate varies from frame to frame, the display frame rate will typically not be an exact multiple of the input frame rate in any given frame. To achieve low latency, the display controllers may use a rolling buffer to enable <4 millisecond latency. A double buffer can also be used. When a new source video frame is being received, to prevent buffer swap artifacts and image tearing with the rolling buffer, display of the current dithered segment is completed while buffering up data from the new source video frame. The display controller may swap the buffer (step the buffer for a rolling buffer) at the end of a dithered segment. Alternatively, the buffer swap can be done after display of a single color segment is complete or after display of a full dithered frame is complete. In some implementations, the rolling buffer that captures new source video data may not be large enough to allow a full color segment or a full dithered frame to be displayed.

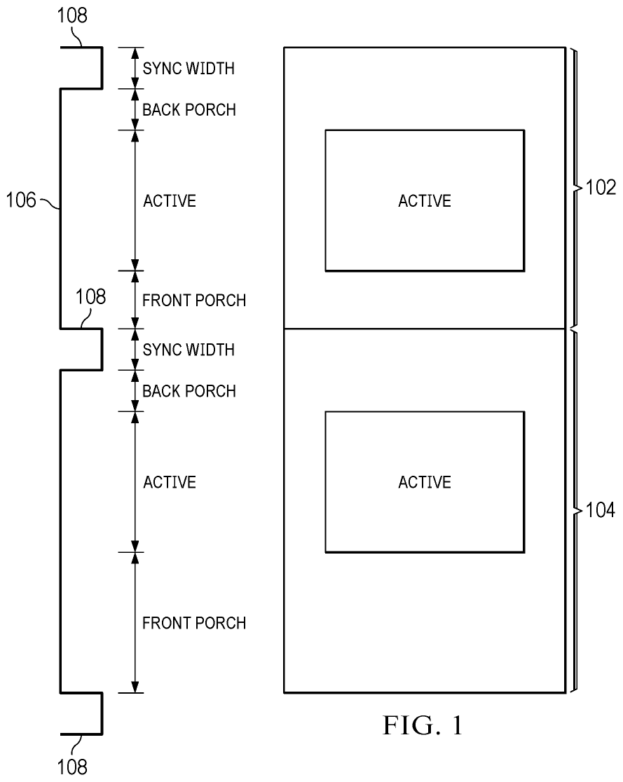

FIG. 1 is an example timing diagram showing display of video frames with a variable refresh rate. FIG. 1 shows video frames 102 and 104, and a sync signal 106. The sync signal 106 includes a pulse 108 that defines the start of video frames 102 and 104. The video frames 102 and 104 include an interval corresponding to the pulse 108, a front porch interval, an active interval, and a back porch interval. The front porch interval defines the time between the end of the pulse 108 and the active interval, and the back porch interval defines the time between the end of the active interval and start of the pulse 108. The active interval is the time during which image data is transferred.

The back porch interval and the active interval have the same duration in the video frames 102 and 104. However, the front porch interval of the video frame 104 is longer than the front porch interval of the video frame 102. Accordingly, the refresh rate of the video may be varied by changing the duration of the front porch interval. A longer front porch interval produces a slower refresh rate, and a shorter front porch interval produces a faster refresh rate. In a system that includes variable refresh rate, a last received video frame should continue to be displayed irrespective of the duration of the front porch interval of a successive video frame.

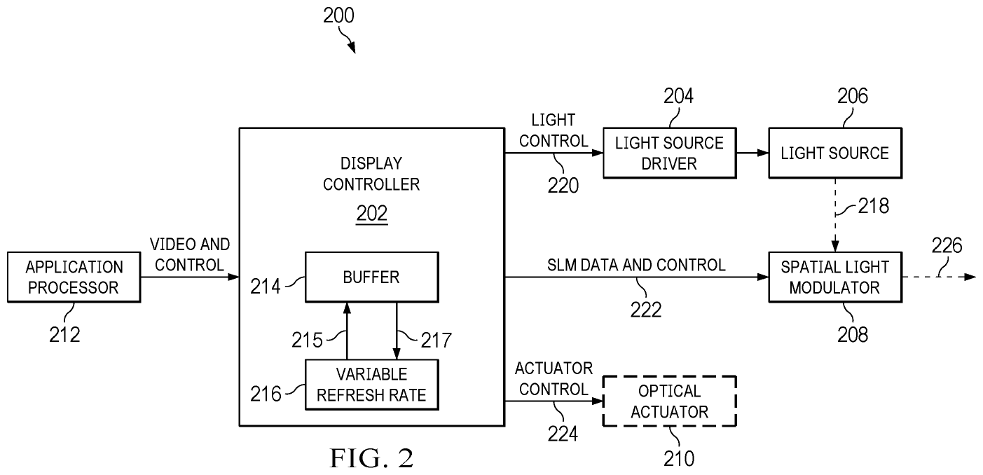

FIG. 2 is a block diagram of an example system 200 that implements display of video with a variable refresh rate. The system 200 includes a display controller 202, a light source driver 204, a light source 206, and a spatial light modulator (SLM) 208. Some examples of the system 200 may also include an optical actuator 210. The display controller 202 is coupled to a video source, such as the application processor 212. The application processor 212 may be implemented as any circuit that provides source video frames and control signals to the display controller 202.

The light source 206 generates light 218 that is provided to the SLM 208. The light source 206 may include, for example, light emitting diodes (LEDs) or laser diodes that generate the light 218. The light 218 generated by the light source 206 may include light of multiple colors (e.g., time multiplexed red, green, and blue light) in some examples.

The light source driver 204 provides voltage and current for operating the light source 206. An output of the light source driver 204 is coupled to an input of the light source 206, and an input of the light source driver 204 is coupled to an output of the display controller 202. The display controller 202 generates the light control signals 220 that are provided to the light source driver 204. The light control signals 220 may control the light source 206 to generate the light 218 as a sequence of colors and/or with varying brightness. The light source driver 204 may change the voltage and/or current (e.g., increase the voltage and/or current) of the light control signals 220 to generate the drive signals provided to the light source 206.

The SLM 208 is optically coupled to the light source 206 and electrically coupled to the display controller 202. The SLM 208 may be a digital micromirror device, a liquid crystal on silicon device, a micro-light emitting diode (microLED) device, or other spatial light modulation device. The SLM 208 receives the light 218, and manipulates the light 218 based on the SLM data and control signals 222 received from the display controller 202 to produce light output 226. For example, the SLM 208 may include an array of pixels (e.g., mirrors, shutters, etc.), and the SLM data and control signals 222 may define a pattern of the pixels of the SLM 208. The pixels of the SLM 208 may reflect or pass the light 218 in a pattern based on the SLM data and control signals 222 to display a video frame.

In implementations of the system 200 that include the optical actuator 210, the optical actuator 210 may be electrically coupled to the display controller 202 and mechanically coupled to an optical plate that is optically coupled to the SLM 208. The optical actuator 210 varies the physical position of the optical plate based on the actuator control signal 224. The optical plate may be positioned between the SLM 208 and the light source 206, or may be positioned to receive the light output 226 from the SLM 208.

For example, the optical actuator 210 may vary the physical position of optical plate by a distance selected to adjust the location of the display generated by the SLM 208 by a fraction of a pixel in one or more directions to increase display resolution.

The display controller 202 includes a buffer memory 214 and a variable refresh rate circuit 216. The buffer memory 214 stores video frames received from the application processor 212. The buffer memory 214 may be divided into two sub-buffers to provide double-buffering. In double-buffering, a first sub-buffer stores an incoming video frame, and a second sub-buffer provides a previously received video frame for use in controlling the light source 206 and the SLM 208. In other examples, the buffer memory 214 may be subdivided into more than two sub-buffers, where each sub-buffer stores a portion of an incoming video frame, and the video data stored in the sub-buffer can be provided for controlling the light source 206 and SLM 208 during reception of subsequent video data. An implementation of the buffer memory 214 subdivided into more than two sub-buffers may operate as a rolling buffer.

In some implementations of the system 200, the application processor 212 may provide source video frames to the display controller 202 at a constant rate. In other implementations of the system 200, the application processor 212 may provide source video frames to the display controller 202 at a variable rate. For example, the application processor 212 may provide a video frame to the display controller 202 only when there is a change in the displayed image relative to the previously provided video frame. In such systems, the rate at which the application processor 212 provides video frames to the display controller 202 can vary, and the variable refresh rate circuit 216 can adaptively adjust the duration of video frame display to accommodate variation in source frame rate. For example, the variable refresh rate circuit 216 can stretch or shrink display frame duration to match the current source frame period of the application processor 212. The variable refresh rate circuit 216 may provide a display frame rate that is asynchronous to the source frame rate. The variable refresh rate circuit 216 avoids dark times by adaptively adjusting the display frame period to match the current source frame period, which avoids average brightness variations caused by source frame rate variation. The variable refresh rate circuit 216 also avoids image tears by completing the display of a frame before starting display of a subsequent frame.

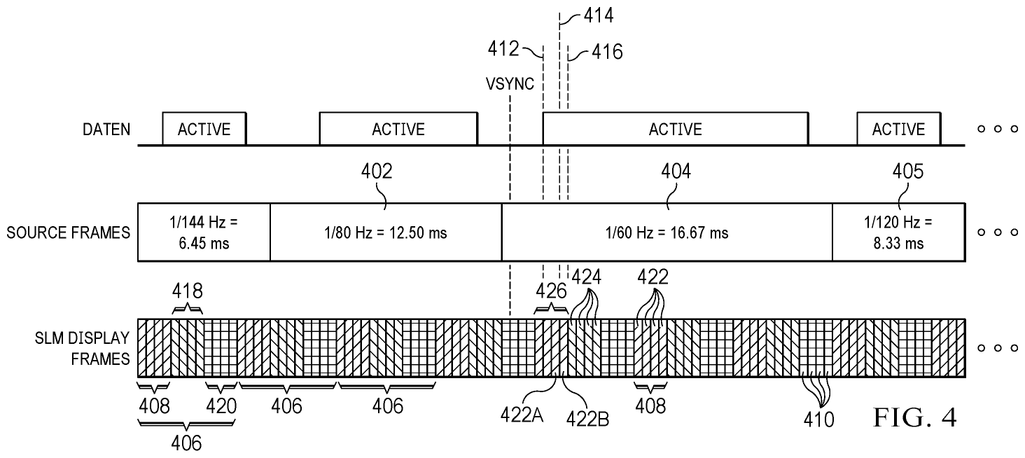

The variable refresh rate circuit 216 may be implemented using a processor of the display controller 202 executing instructions stored in memory of the display controller 202 to provide the functionality described herein. In some examples, the variable refresh rate circuit 216 may be implemented using hardware circuits that provide the functionality described herein. The variable refresh rate circuit 216 provides write data 215 to be stored in the buffer memory 214. The write data 215 may be source video received from the application processor 212. The variable refresh rate circuit 216 retrieves read data 217 from the buffer memory 214. The read data may be video data provided to the SLM 208 as part of the SLM data and control signals 222. The functionality of the variable refresh rate circuit 216 is further described by reference to FIGS. 4-12.

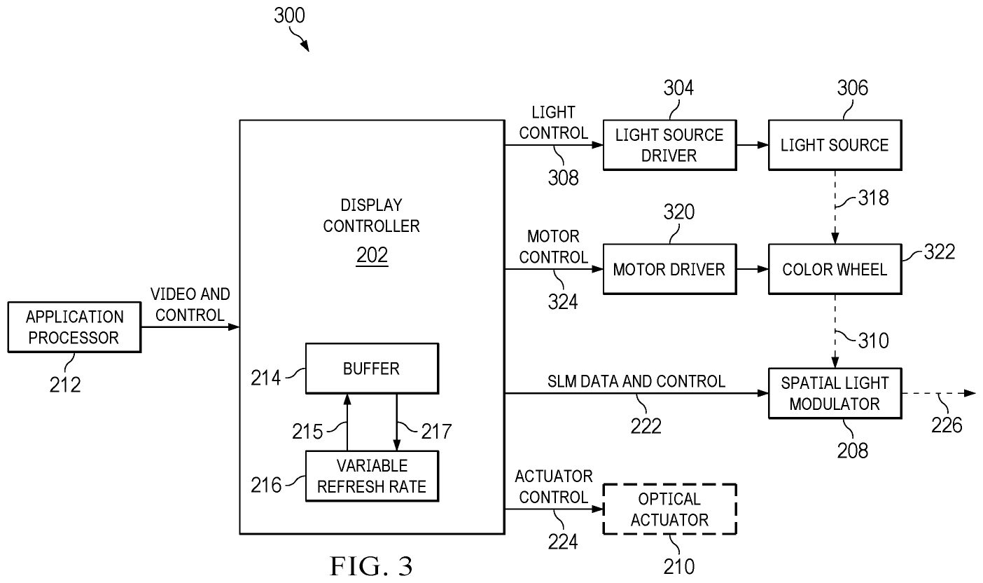

FIG. 3 is a block diagram of an example system 300 that implements display of video with a variable refresh rate. The system 300 is similar to the system 200, but uses a color wheel to generate the different light colors provided to the SLM 208. The system 300 includes a display controller 302, a light source driver 304, a light source 306, the SLM 208, a motor driver 320, and a color wheel 322. The display controller 302 is similar to the display controller 202, and provides color wheel control. Some examples of the system 300 may also include the optical actuator 210. The display controller 302 is coupled to the application processor 212.

The light source 306 generates light 318 that is provided to the color wheel 322. The light source 206 may include, for example, an LED or laser diode that generates the light 318. The light 318 generated by the light source 206 may include light of a single color (e.g., blue) in some examples.

The light source driver 304 provides voltage and current for operating the light source 306. An output of the light source driver 304 is coupled to an input of the light source 306, and an input of the light source driver 304 is coupled to an output of the display controller 302. The display controller 302 generates the light control signal 308 that is provided to the light source driver 304. The light control signal 308 may control the light source 306 to generate the light 318 with varying brightness. The light source driver 304 may change the voltage and/or current (e.g., increase the voltage and/or current) of the light control signal 308 to generate the drive signal provided to the light source 306.

The color wheel 322 receives the light 318 and may change the color of the light 318 to provide multi-colored light 310 to the SLM 208. Multi-colored light refers to light that changes color over time (e.g., red at a first time, blue at a second time, green at a third time). In some implementations, the color wheel 322 may be a phosphor wheel, which is a rotating wheel having at least some segments that convert the wavelength of light 318. For example, the color wheel 322 may have a yellow phosphor segment that converts blue light to yellow light (red and green combined to make yellow) or a green phosphor segment to produce green light from the blue light. The phosphor wheel may also optionally have a segment that is reflective or transmissive, that propagates the blue light. A phosphor wheel may be used with a blue laser. An additional element that might be used is a rotating color filter, which may, for example, have a red segment, a green segment, and a blue segment. The color filter might be used in combination with the phosphor color wheel or in its own without a phosphor color wheel. A rotating color wheel may also be combined with a static phosphor, which may be a yellow phosphor or a white phosphor. The color wheel 322 includes a motor coupled to the color filter and/or phosphor wheel. The motor rotates the color filter and/or phosphor wheel. The light 318 passes through the color filter and/or phosphor wheel to produce the multi-colored light 310.

The motor driver 320 provides voltage and current for operating the color wheel 322 (e.g., for operating the motor of the color wheel 322). An output of the motor driver 320 is coupled to an input of the color wheel 322, and an input of the motor driver 320 is coupled to an output of the display controller 302. The display controller 302 generates the motor control signal 324 that is provided to the motor driver 320. The motor driver 320 may change the voltage and/or current (e.g., increase the voltage and/or current) of the motor control signal 324 to generate the drive signal provided to the color wheel 322.

The SLM 208 is optically coupled to the color wheel 322 and electrically coupled to the display controller 302. The SLM 208 may be a digital micromirror device, a liquid crystal on silicon device, or other spatial light modulation device. The SLM 208 receives the multi-colored light 310, and manipulates the multi-colored light 310 based on the SLM data and control signals 222 received from the display controller 302. For example, the SLM 208 may include an array of pixels (e.g., mirrors, shutters, etc.), and the SLM data and control signals 222 may define a pattern of the pixels of the SLM 208. The pixels of the SLM 208 may reflect or pass the multi-colored light 310 in a pattern based on the SLM data and control signals 222 to display a video frame.

The buffer memory 214 and the variable refresh rate circuit 216 operate as described with regard to the display controller 202. Functionality of the variable refresh rate circuit 216 is further described by reference to FIGS. 4-12.

FIG. 4 is a timing diagram illustrating example source and display frame timing in the system 200 or the system 300. FIG. 4 shows a source video frames 402, 404, and 405 provided by the application processor 212 and received by the variable refresh rate circuit 216. In FIG. 4, the signal DATEN may be a control signal provided by the application processor 212 indicating source frame data validity. For example, DATAEN may have a first logic state to indicate the that source frame data is valid, and a second logic to state to indicate that source frame data is not valid. The source video frame 402 has a period of 12.5 milliseconds (ms) and the source video frame 404 has a period of 16.67 ms. Accordingly, the rate of the source frames received from the application processor 212 varies. The variable refresh rate circuit 216 starts to receive the source video frame 404 at time 912 after DATEN is activated during the source video frame 404. During reception of the source video frame 404, the variable refresh rate circuit 216 may provide a dithered segment of the source video frame 402 (e.g., a dithered segment of the color segment 426, the color segment 426 is an example of the color segment 408) including instructions to display the dithered segment.

FIG. 4 shows that the variable refresh rate circuit 216 provides display frames to the SLM 208 as dithered frames (e.g., dithered frame 406). A dithered frame is a set (e.g., the smallest set) of color segments (e.g., red, green, and blue segments) that represents a video frame at full-bit depth. FIG. 4 shows multiple dithered frames 406. Different color segments are represented by different hatching in dithered frame 406. For example, color segment 408 is shown with unique hatching that may represent red. Color segment 418 is shown with unique hatching that may represent green. Color segment 420 is shown with unique hatching that may represent blue. In FIG. 4, each set of color segments 408, 418, and 420 (as represented by the provided hatching) represents a dithered frame 406. Each color segment shows a complete frame at full bit depth. Each color segment includes multiple dithered segments. For example, the color segment 420 includes dithered segments 410, the color segment 408 includes dithered segments 422, and the color segment 418 includes dithered segments 424. A dithered segment is a portion of color segment that represents a color frame at full bit depth.

The variable refresh rate circuit 216 starts to receive the source video frame 404 at time 412 after DATEN is activated during the source video frame 404. During reception of the source video frame 404, the variable refresh rate circuit 216 may continue to provide data of the source video frame 402 to the SLM 208 until a portion of the source video frame 404 has been received, and thereafter provide data of the source video frame 404 to the SLM 208.

In FIG. 4, after receipt of the source video frame 404 starts at time 412, and a selected portion of the source video frame 404 has been received, display of a dithered segment 422A of the source video frame 402 is complete at time 414. A selected portion of the source video frame 404 may be the entire source video frame 404, a color segment of the source video frame 404, a dithered frame of the source video frame 404, a dithered segment of the source video frame 404, or other portion of the source video frame 404. Responsive to receipt of the selected portion of the source video frame 404, and display of the dithered segment 422A of the source video frame 402 being complete, the variable refresh rate circuit 216 provides a dithered segment 422B of the source video frame 404, including instructions to display the dithered segment of the second video frame, to the SLM 208.

Examples of the variable refresh rate circuit 216 may also delay providing data of the source video frame 404 to the SLM 208 until display of a color segment of the source video frame 402 is complete at time 916. After variable refresh rate circuit 216 starts providing data of the source video frame 404 to the SLM 208, the variable refresh rate circuit 216 continues to provide data of the source video frame 404 to the SLM 208 until receipt of a subsequent source video frame 405, and the operations described with respect to times 412, 414, and 416 are applied to transition from the source video frame 404 to the source video frame 405.

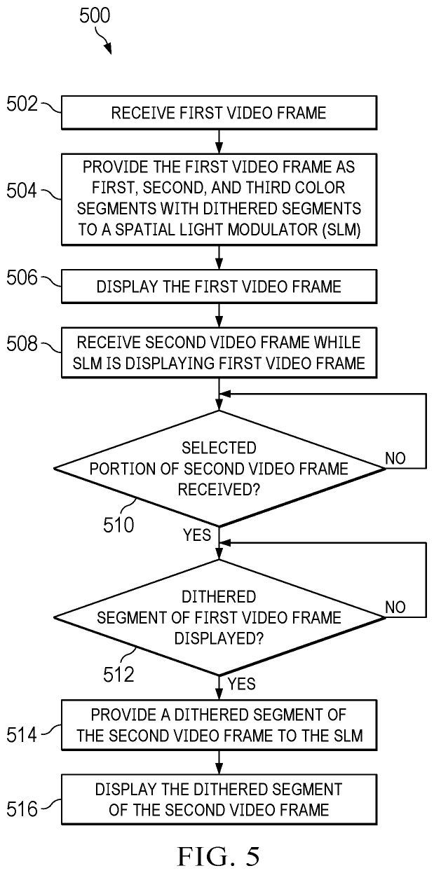

FIG. 5 is a flow diagram for a method 500 of displaying video with a variable refresh rate. Though depicted sequentially as a matter of convenience, at least some of the illustrated operations can be performed in a different order and/or performed in parallel. Additionally, some implementations may perform only some of the operations illustrated. Operations of the method 500 may be performed by the system 200 or 300, and more specifically by the display controller 202 or 302 and the SLM 208.

In block 502, the variable refresh rate circuit 216 receives a first video frame (e.g., source video frame 402) from the application processor 212. As shown in FIG. 4, the source video frame 402 has a period of 12.5 milliseconds (ms).

In block 504, the variable refresh rate circuit 216 generates, from the first video frame, first, second, and third color segments with dithered segments, and provides the first, second, and third color segments with dithered segments to the SLM 208.

In block 506, the SLM 208 displays the first video frame. Displaying the first video frame includes displaying the dithered segments generated from the of the first video frame in block 504.

In block 508, the variable refresh rate circuit 216 receives a second video frame (e.g., the source video frame 404) from the application processor 212 while the SLM 208 is displaying the first video frame. FIG. 4 shows the source video frame 404, with a period of 16.67 ms, provided by the application processor 212 and received by the variable refresh rate circuit 216.

In blocks 510 and 512, display of the second video frame is delayed until a selected portion of the second video frame has been received, and display of a dithered segment of the first video frame is complete thereafter. A selected portion of the second video frame may be the entire second video frame (e.g., the entire source video frame 404), a color segment of the second video frame, a dithered frame of the second video frame, a dithered segment of the second video frame, or other portion of the second video frame in various implementations of the method 500.

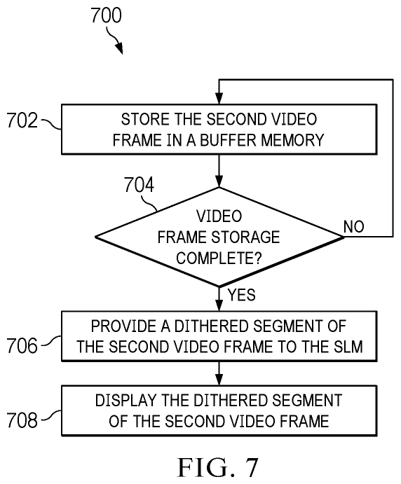

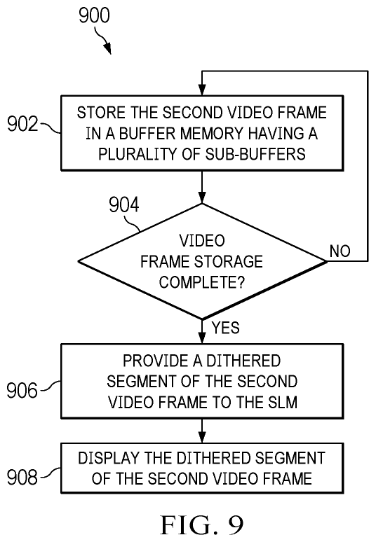

In block 510, the variable refresh rate circuit 216 is receiving the second video frame. If a selected portion of the second video frame has been received by the variable refresh rate circuit 216, then the method 500 continues in block 512. If the selected portion of the second video frame has not been received by the variable refresh rate circuit 216, then receipt of the second video frame continues until the selected portion has been received. Further explanation of receipt of the second video frame is provided with reference to FIGS. 7 and 9.

In block 512, the SLM 208 is displaying the first video frame. If the display of a dithered segment (e.g., dithered segment 422A shown in FIG. 4) of the first video frame is complete, then the method 500 continues in block 514. In FIG. 4, after receipt of the source video frame 404 starts at time 412, and a selected portion of the source video frame 404 has been received, display of a dithered segment 422A of the source video frame 402 is complete at time 414. If the display of a dithered segment of the first video frame is not complete, then display of the first video frame continues until display of a dithered segment is complete.

In block 514, responsive to receipt of the selected portion of the second video frame, and display of a dithered segment of the first video frame (e.g., the dithered segment 422A) being complete, the variable refresh rate circuit 216 provides a dithered segment of the second video frame (e.g., dithered segment 422B shown in FIG. 4), including instructions to display the dithered segment of the second video frame, to the SLM 208.

In block 516, the SLM 208 displays the dithered segment of the second video frame, thereby initiating display of the second video frame. After variable refresh rate circuit 216 starts providing data of the second video frame to the SLM 208, the variable refresh rate circuit 216 continues to provide data of the second video frame to the SLM 208 until receipt of a third video frame, and the operations of the method 500 are performed to transition from display of the second video frame to display of the third video frame.

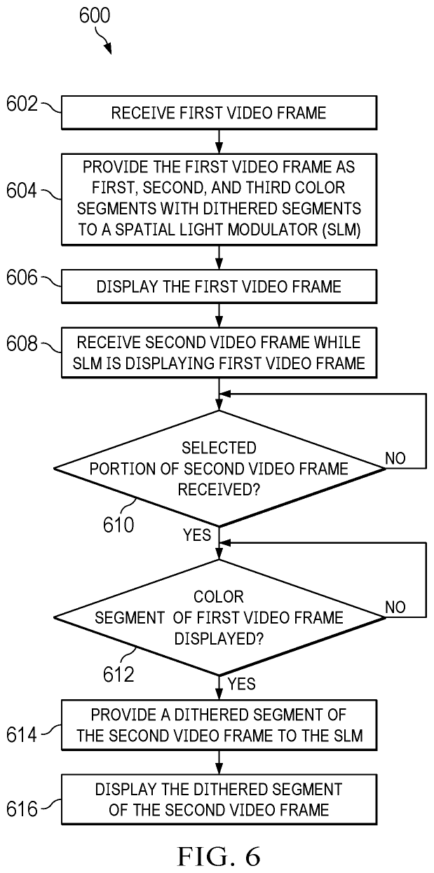

FIG. 6 is a flow diagram for a method 600 of displaying video with a variable refresh rate. Though depicted sequentially as a matter of convenience, at least some of the illustrated operations can be performed in a different order and/or performed in parallel. Additionally, some implementations may perform only some of the operations illustrated. Operations of the method 600 may be performed by the system 200 or 300, and more specifically by the display controller 202 or 302 and the SLM 208. The method 600 is similar to the method 500, with transition between source video frames at a color segment boundary rather than a dithered segment boundary.

In block 602, the variable refresh rate circuit 216 receives a first video frame (e.g., source video frame 402) from the application processor 212. As shown in FIG. 4, the source video frame 402 has a period of 12.5 milliseconds (ms).

In block 604, the variable refresh rate circuit 216 generates, from the first video frame, first, second, and third color segments with dithered segments, and provides the first, second, and third color segments with dithered segments to the SLM 208.

In block 606, the SLM 208 displays the first video frame. Displaying the first video frame includes displaying the dithered segments generated from the of the first video frame in block 504.

In block 608, the variable refresh rate circuit 216 receives a second video frame (e.g., the source video frame 404) from the application processor 212 while the SLM 208 is displaying the first video frame. FIG. 4 shows the source video frame 404, with a period of 16.67 ms, provided by the application processor 212 and received by the variable refresh rate circuit 216.

In blocks 610 and 612, display of the second video frame is delayed until a selected portion of the second video frame has been received, and display of a color segment of the first video frame is complete thereafter. A selected portion of the second video frame may be the entire second video frame (e.g., the entire source video frame 404), a color segment of the second video frame, a dithered frame of the second video frame, a dithered segment of the second video frame, or other portion of the second video frame in various implementations of the method 500.

In block 610, the variable refresh rate circuit 216 is receiving the second video frame. If a selected portion of the second video frame has been received by the variable refresh rate circuit 216, then the method 600 continues in block 612. If the selected portion of the second video frame has not been received by the variable refresh rate circuit 216, then receipt of the second video frame continues until the selected portion has been received. Further explanation of receipt of the second video frame is provided with reference to FIGS. 7 and 9.

In block 612, the SLM 208 is displaying the first video frame. If the display of a color segment (e.g., color segment 426 shown in FIG. 4) of the first video frame is complete, then the method 600 continues in block 614. In FIG. 4, after receipt of the source video frame 404 starts at time 412, and a selected portion of the source video frame 404 has been received, display of a color segment 426 of the source video frame 402 is complete at time 416. If the display of a color segment is not complete, then display of the first video frame continues until display of a color segment currently being displayed is complete.

In block 614, responsive to receipt of the selected portion of the second video frame, and display of a color segment of the first video frame (e.g., the color segment 426) being complete, the variable refresh rate circuit 216 provides a dithered segment of the second video frame (e.g., dithered segment 424 shown in FIG. 4), including instructions to display the dithered segment of the second video frame, to the SLM 208.

In block 616, the SLM 208 displays the dithered segment of the second video frame, thereby initiating display of the second video frame. After variable refresh rate circuit 216 starts providing data of the second video frame to the SLM 208, the variable refresh rate circuit 216 continues to provide data of the second video frame to the SLM 208 until receipt of a third video frame, and the operations of the method 600 are performed to transition from display of the second video frame to display of the third video frame.

FIG. 7 is a flow diagram for a method 700 of triggering providing a dithered segment of a video frame responsive to storage of a video frame. Though depicted sequentially as a matter of convenience, at least some of the illustrated operations can be performed in a different order and/or performed in parallel. Additionally, some implementations may perform only some of the operations illustrated. Operations of the method 700 may be performed in conjunction with operations of the methods 500 or 600, and may be performed by the system 200 or 300, and more specifically by the display controller 202 or 302. For example, the variable refresh rate circuit 216 may receive a first video frame from the application processor 212 in block 502 of the method 500.

In block 702, the variable refresh rate circuit 216 receives a second video frame from the application processor 212. The operations of block 702 may be performed as part of the operations of block 508 of the method 500 or block 608 of the method 600. The variable refresh rate circuit 216 stores the second video frame in the buffer memory 214. The buffer memory 214 may be subdivided into two sub-buffers (a double buffer), where each of the sub-buffers can store an entire video frame. The variable refresh rate circuit 216 can store the complete second video frame in one of the sub-buffers of the buffer memory 214.

In block 704, the variable refresh rate circuit 216 determines whether storage of the second video frame, or a selected portion thereof, is complete. For example, a selected portion of the second video frame may be a color segment or a dithered segment of the second video frame.

If storage of the selected portion of the second video frame is complete in block 704, then responsive to completion of storage of the second video frame in the buffer memory, the variable refresh rate circuit 216 provides a dithered segment of the second video frame to the SLM 208 in block 706.

In block 708, the SLM 208 displays the dithered segment of the second video frame received in block 706. Operations of the method 700 may be performed any number of times as part of the method 500 or the method 600.

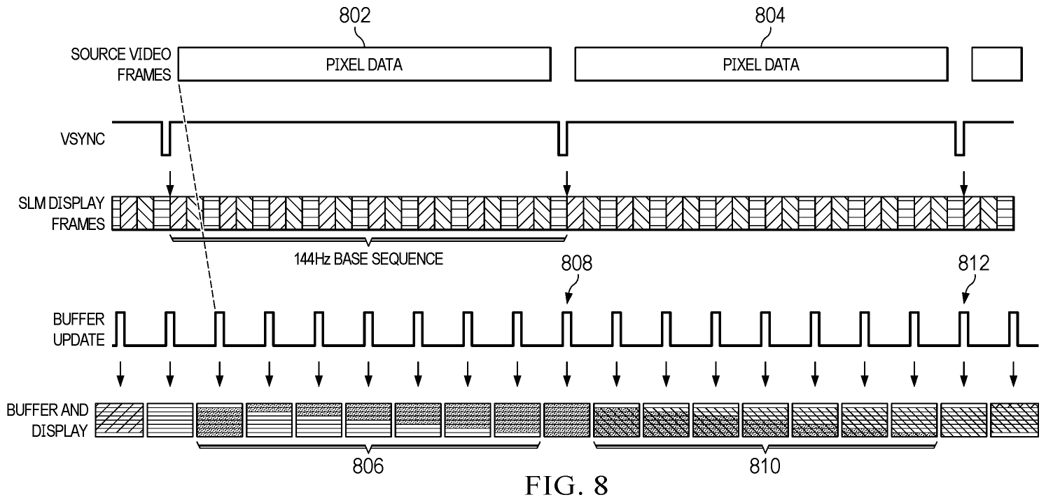

FIG. 8 is a timing diagram illustrating example reception of a video frame with storage in buffer that is subdivided into multiple sub-buffers to form a rolling buffer. FIG. 8 illustrates the storage and display of SOURCE VIDEO FRAMES 802 and 804. The signal VSYNC indicates the start of a new source video frame. The variable refresh rate circuit 216 can control the SLM 208 by providing SLM DISPLAY FRAMES at a synchronous multiple of the source frame rate in FIG. 8. For example, if the application processor 212 provides the SOURCE VIDEO FRAMES 802 and 804 at a frame rate N, then the variable refresh rate circuit 216 can control the SLM 208 by providing SLM DISPLAY FRAMES at a rate M*N, where M is an integer. The BUFFER UPDATE signal illustrates an example of timing for updating a sub-buffer of the buffer memory 214. As the SOURCE VIDEO FRAME 802 is received, sub-buffers of the buffer memory 214 are sequentially updated, each sub-buffer storing a selected portion (e.g., a slice including multiple rows of the source video frame). As each sub-buffer is updated, the stored data for the current source video frame increases, and the stored data for the previous source video frame decreases. In the sequence 806 the stored data of the SOURCE VIDEO FRAME 802 increases with each buffer update, until, at the BUFFER UPDATE 808, the complete SOURCE VIDEO FRAME 802 has been stored. Similarly, in the sequence 810, the stored data of the SOURCE VIDEO FRAME 804 increases and the stored data of the SOURCE VIDEO FRAME 802 decreases, until, at the BUFFER UPDATE 812, the complete SOURCE VIDEO FRAME 804 has been stored.

FIG. 9 is a flow diagram for a method 900 of triggering provision of a dithered segment of a video frame responsive to storage of a portion of a video frame. Though depicted sequentially as a matter of convenience, at least some of the illustrated operations can be performed in a different order and/or performed in parallel. Additionally, some implementations may perform only some of the operations illustrated. Operations of the method 900 may be performed in conjunction with operations of the methods 500 or 600, and may be performed by the system 200 or 300, and more specifically by the display controller 202 or 302. For example, the variable refresh rate circuit 216 may receive a first video frame from the application processor 212 in block 502 of the method 500.

In block 902, the variable refresh rate circuit 216 receives a second video frame from the application processor 212. The operations of block 902 may be performed as part of the operations of block 508 of the method 500 or block 608 of the method 600. The variable refresh rate circuit 216 stores the second video frame in the buffer memory 214. The buffer memory 214 may be subdivided into a plurality of sub-buffers (a rolling buffer), where each of the sub-buffers can store a sub-portion of a video frame (less than the entire video frame). As the variable refresh rate circuit 216 receives the second video frame, the variable refresh rate circuit 216 stores the second video frame in the sub-buffers of the buffer memory 214 as described in FIG. 8.

In block 904, the variable refresh rate circuit 216 determines whether storage of the second video frame, or a selected portion thereof, is complete. For example, a selected portion of the second video frame may be a color segment or a dithered segment of the second video frame.

If storage of the selected portion of the second video frame is complete in block 904, then the variable refresh rate circuit 216 provides a dithered segment of the second video frame to the SLM 208 in block 906.

In block 908, the SLM 208 displays the dithered segment of the second video frame received in block 906. Operations of the method 900 may be performed any number of times as part of the method 500 or the method 600.

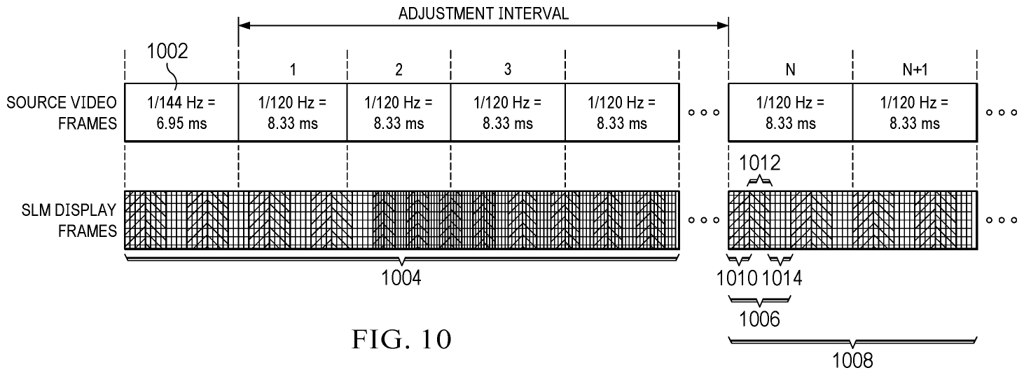

FIG. 10 is a timing diagram illustrating example display frame rate adjustment based on variable refresh rate source video. FIG. 10 illustrates SOURCE VIDEO FRAMES and SLM DISPLAY FRAMES. The application processor 212 provides the SOURCE VIDEO FRAMES with variable rate, a frame 1002 has a period of 6.95 ms, and all other frames have a period of 8.33 ms. In the interval 1004, the variable refresh rate circuit 216 controls the SLM 208 to provide the SLM DISPLAY FRAMES asynchronous to the SOURCE VIDEO FRAMES. The variable refresh rate circuit 216 may adjust the timing of the SLM DISPLAY FRAMES relatively slowly (e.g., a small adjustment with each SOURCE VIDEO FRAME) over an adjustment interval (e.g., 1 second) to bring the SLM DISPLAY FRAMES into synchronization with the SOURCE VIDEO FRAMES. For example, the variable refresh rate circuit 216 may execute a background task that frame-by-frame continuously adjusts clock dropping to slowly make the display frame rate an exact multiple of the source frame rate. In one example, a ˜1.0 second time constant (programmable time constant in some examples) is used to make the adjustment slow. If the source frame rate stabilizes, after roughly 1.0 second the display frame rate will be an exact multiple of the source frame rate, and the display frame rate will become fully synchronous to the source frame rate. The frame-by-frame clock dropping adjustments may be disabled for cases where the display frame rate has been set to a fixed rate while still supporting variable refresh rate (e.g., for using the optical actuator 210 and/or the color wheel 322).

In the interval 1008 (at the end of the adjustment interval), the variable refresh rate circuit 216 has adjusted the rate of SLM DISPLAY FRAMES to be synchronous with the SOURCE VIDEO FRAMES.

The dithered frame 1006 shown in FIG. 10 represents one of an integer number of dithered frames displayed for a SOURCE VIDEO FRAME in the interval 1008. A dithered frame is a set (e.g., the smallest set) of color segments (e.g., red, green, and blue segments) that represents a video frame at full-bit depth. Different color segments are represented by different hatching in dithered frame 1006. For example, color segment 1010 is shown with unique hatching that may represent red. Color segment 1012 is shown with unique hatching that may represent green. Color segment 1014 is shown with unique hatching that may represent blue. In FIG. 10, each set of color segments 1010, 1012, and 1014 (as represented by the provided hatching) represents a dithered frame 1006. Each color segment shows a complete frame at full bit depth. Each color segment includes multiple dithered segments. For example, the color segment 1010 includes dithered segments. A dithered segment is a portion of color segment that represents a color frame at full bit depth.

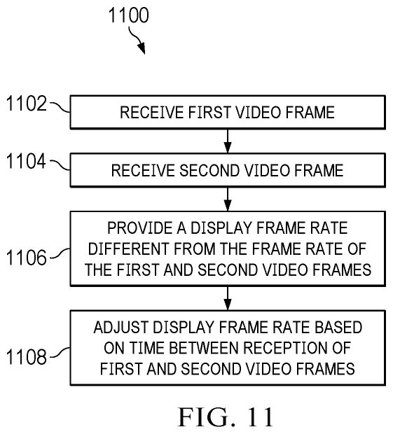

FIG. 11 is a flow diagram for a method 1100 of providing a display frame rate in a system with a variable refresh rate. Though depicted sequentially as a matter of convenience, at least some of the illustrated operations can be performed in a different order and/or performed in parallel. Additionally, some implementations may perform only some of the operations illustrated. Operations of the method 1100 May be performed by the system 200 or 300, and more specifically by the display controller 202 or 302. The method 1100 May be applied in conjunction with the methods 500, 600, 700, and/or 900.

In block 1102, the variable refresh rate circuit 216 receives a first video frame (e.g., source video frame 402) from the application processor 212.

In block 1104, the variable refresh rate circuit 216 receives a second video frame (e.g., source video frame 404) from the application processor 212. The period of the second video frame may be different from the period of the first video frame. The period is the duration of the video frame. FIG. 4 shows that source video frame 402 has a period of 12.5 ms and the source video frame 404 has a period of 16.67 ms.

Some examples of the method 1100 May adjust the display frame rate based on the source frame rate or provide a display frame rate that is different from the source frame rate. In block 1106, the variable refresh rate circuit 216 provides video data for display at a display frame rate that is different from the frame rate of the first and second video frames. For example, the display frame rate provided by the variable refresh rate circuit 216 may be asynchronous to the source frame rate. The variable refresh rate circuit 216 may provide a fixed display frame rate that is asynchronous to the source frame rate in examples of the system 200 or the system 300 that employ the optical actuator 210 and/or the color wheel 322. In such systems, the display frame rate may be synchronous to the optical actuator 210 and/or the color wheel 322. For example, the vibration rate of the optical actuator 210 may be fixed, and/or the rotation rate of the color wheel 322 may be fixed. The display frame rate may be fixed and synchronized to the fixed vibration rate of the optical actuator 210, and/or the fixed rotation rate of the color wheel 322. The application processor 212 may provide source video frames at a rate that is different from the display frame rate. For example, the application processor 212 may provide source video frames at a variable rate, or at a rate that is different from the display frame rate.

In block 1108, the variable refresh rate circuit 216 adjusts the display frame rate based on the period of the first video frame and the second video frame. For example, the variable refresh rate circuit 216 may adjust the display frame rate such the display frame rate is synchronous to the source frame rate. Over a selected time interval (e.g., 1 second), the variable refresh rate circuit 216 may continuously adjust the timing of display frame generation to generate a display frame rate that is an integer multiple of the source frame rate as shown in FIG. 10.

Because the variable refresh rate circuit 216 allows the source video frame rate to vary, the variable refresh rate circuit 216 works with a wide range of display system configurations. For systems using the color wheel 322, with or without the optical actuator 210, if the source frame rate is fixed, the color wheel 322 may be locked to a multiple of the source frame rate and the display frame rate may be locked to the color wheel 322. For example, if the source frame rate is 60 Hz, the CW may be run at 120 Hz and the display frame rate may be 120 Hz. The color wheel 322 may be locked to the source frame rate if the source frame rate is stable meaning it meets these conditions: 1) at power-up the source frame rate is within +/−0.2 Hz for 10 frames; and 2) during run-time the source frame rate stays within +/−0.2Hz for more than 300 frames. For both conditions 1) and 2), the frame rate tolerance and number of frames may be programmable.

If the source frame rate is varying, the color wheel 322 speed is set to a fixed frequency so that it runs asynchronous to the source frame rate. This is to avoid trying to make the color wheel 322 speed track the source frame rate. The display frame rate is locked to the color wheel 322. The color wheel 322 speed may be set to a nominal rating for the system, e.g., 120 Hz, 240 Hz etc. Rolling buffer timing in a frame may be the same as in systems not using the color wheel 322. When the rolling buffer starts stepping to display new data after arrival of a new source video frame, the color at the first buffer swap is random. If the optical actuator 210 is being used, the subframe when the first buffer swap occurs is also random.

For systems not using the color wheel 322, with or without the optical actuator 210, if not using the optical actuator 210, or where the optical actuator 210 can run at the source frame rate, the display frame rate may be locked to source frame rate. In systems using the optical actuator 210, if the source frame rate is varying (not within +/−0.2Hz for >N frames) and not within the range supported by the optical actuator 210, the display frame rate may be fixed to a rate that is asynchronous to the source frame rate. Rolling buffer timing is identical with or without the optical actuator 210. When the rolling buffer starts stepping to display newly arrived source video frame data, the color at the buffer swap is random. If the optical actuator 210 is being used, the subframe when the first buffer swaps occurs is also random. This allows source frame rates to be higher than the optical actuator 210 can keep up with. For example, the source frame rate may be 144 Hz, but the actuator and display frame rate may be set to 60 Hz (240 Hz subframe rate).

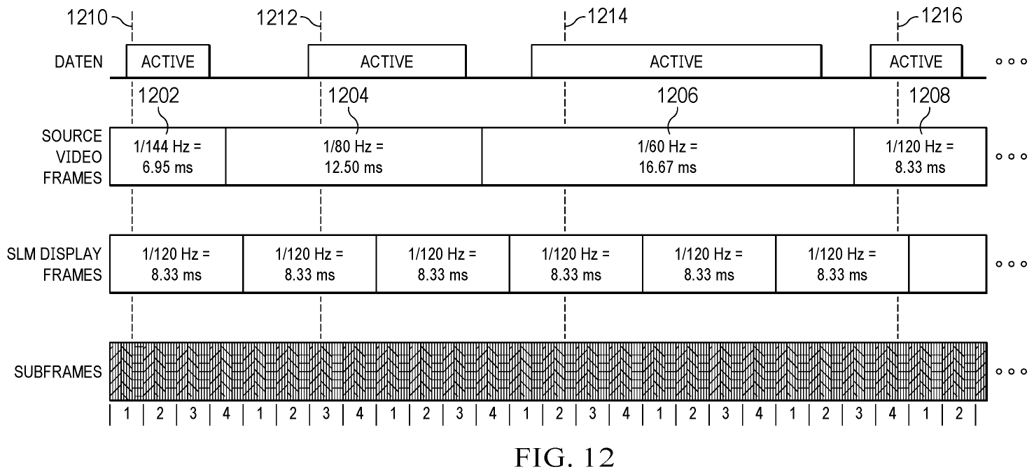

FIG. 12 is a timing diagram illustrating example source and display frame timing in an example of the system 200 or 300 using the optical actuator 210 and/or the color wheel 322 with variable refresh rate. The optical actuator 210 may be mechanically coupled to an optical plate that is optically coupled to the SLM 208, and electrically coupled to the display controller 202. The optical actuator 210 varies the physical position of the optical plate based on the actuator control signal 224. For example, the optical actuator 210 may vary the physical position of optical plate by a distance selected to adjust the location of the display generated by the SLM 208 by a fraction of a pixel in one or more directions to increase display resolution. The display controller 202 provides display data for each physical location of the optical plate to provide the increased display resolution (e.g., 433 the resolution of the SLM 208). The optical actuator 210, and/or the color wheel 322 may operate at a fixed rate that the affects the display rate provided by the display controller 202. The variable refresh rate circuit 216 allows the display controller 202 to receive source video frames from the application processor 212 at a source video frame rate and provide display data to the SLM 208 at a display frame rate that is different from the source video frame rate.

FIG. 12 illustrates SOURCE VIDEO FRAMES and SLM DISPLAY FRAMES. The SOURCE VIDEO FRAMES provided by the application processor 212 include SOURCE VIDEO FRAMES 1202, 1204, 1206, and 1208, each having a different period. In FIG. 12, the signal DATEN may be a control signal provided by the application processor 212 indicating source frame data validity. For example, DATAEN may have a first logic state to indicate the that source frame data is valid, and a second logic to state to indicate that source frame data is not valid. The variable refresh rate circuit 216 controls the SLM 208, the optical actuator 210, and the color wheel 322 to provide the SLM DISPLAY FRAMES at a fixed display frame rate that is not derived from (is independent of) the rate of the SOURCE VIDEO FRAMES. In FIG. 12, the SLM DISPLAY FRAMES are provided with a constant 8.33 ms period, irrespective of the period of the SOURCE DATA FRAMES. SUBFRAMES (e.g., dithered frames) of the SLM DISPLAY FRAMES are also shown.

As explained with reference to the methods 400 and 500, the variable refresh rate circuit 216 initiates display of a SOURCE VIDEO FRAME after receipt of a selected portion of the SOURCE VIDEO FRAME and after completion of display of a dithered segment of the current SLM DISPLAY FRAME. At initiation of display of a SOURCE VIDEO FRAME, the data displayed may be a combination of the data from the previous SOURCE VIDEO FRAME and the data of the current SOURCE VIDEO FRAME as explained with regard to FIG. 8. In FIG. 12, display of a SOURCE VIDEO FRAME may start with completion of display of a color segment. In FIG. 12, display of the SOURCE VIDEO FRAME 1202 May begin at time 1210. Display of the SOURCE VIDEO FRAME 1204 May begin at time 1212. Display of the SOURCE VIDEO FRAME 1206 May begin at time 1214. Display of the SOURCE VIDEO FRAME 1208 May begin at time 1216.

At times 1210, 1212, 1214, and 1216, display of a dithered segment of the prior source video frame is complete, while data from the current source video frame is being buffered. If using a rolling buffer, the buffer may be restarted by providing the data stored in the first buffer section for display. Initiation of display of the current source video frame may occur at a random color and random subframe. In some examples, dark time may be included in a subframe.

In this description, the term “couple” May cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include additional or different components to provide functionality at least partially similar to functionality available prior to the component replacement.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

What is claimed is:

1. A display controller including:
a variable refresh rate circuit configured to:
receive a first video frame;
provide a first dithered segment of the first video frame comprising instructions to display the first dithered segment during reception of a second video frame; and
responsive to reception of the second video frame and completion of display of the first dithered segment, provide a second dithered segment of the second video frame comprising instructions to display the second dithered segment.

2. The display controller of claim 1, wherein the display controller includes a buffer configured to store the second video frame, and the variable refresh rate circuit is configured to provide the second dithered segment responsive to completion of storage of the second video frame in the buffer.

3. The display controller of claim 1, wherein the display controller includes a buffer subdivided into a plurality of sub-buffers configured to store the second video frame, and the variable refresh rate circuit is configured to provide the second dithered segment responsive to completion of storage of a portion the second video frame in one of the sub-buffers.

4. The display controller of claim 1, wherein the variable refresh rate circuit is configured to adjust a display frame rate based on a time between reception of the first video frame and reception of the second video frame.

5. The display controller of claim 1, wherein:
the display controller is configured to provide the first video frame as first, second, and third color segments; and
the variable refresh rate circuit is configured to provide the color segments until reception of the second video frame.

6. The display controller of claim 5, wherein:
the color segments include multiple dithered segments; and
the variable refresh rate circuit is configured to provide the second dithered segment of the second video frame responsive to completion of display of one of the color segments or completion of display of the first video frame.

7. The display controller of claim 1, wherein the variable refresh rate circuit is configured to provide a display frame rate that is different from a source frame rate of the first video frame and the second video frame.

8. A method comprising:
receiving, by a display controller, a first video frame;
providing, by the display controller, the first video frame as first, second, and third color segments to a spatial light modulator (SLM), in which the color segments include multiple dithered segments;
receiving, by the display controller, a second video frame while the first video frame is being displayed by the SLM; and
providing, by the display controller, a dithered segment of the second video frame to the SLM responsive to receipt of the second video frame and completion of display of a dithered segment of the first video frame.

9. The method of claim 8, further comprising:
storing the second video frame in a buffer memory of the display controller; and
providing, by the display controller, the dithered segment of the second video frame to the SLM responsive to completion of storage of the second video frame in the buffer memory.

10. The method of claim 8, further comprising:
storing the second video frame in a buffer memory of the display controller that is subdivided into a plurality of sub-buffers; and
providing, by the display controller, the dithered segment of the second video frame responsive to completion of storage of a portion the second video frame in one of the sub-buffers.

11. The method of claim 8, further comprising adjusting, by the display controller, a display frame rate based on a time between reception of the first video frame and reception of the second video frame.

12. The method of claim 8, further comprising providing the color segments of the first video frame until reception of the second video frame.

13. The method of claim 8, further comprising displaying the dithered segment of the second video frame responsive to completion of display of one of the color segments of the first video frame.

14. The method of claim 8, further comprising providing, by the display controller, a display frame rate that is different from a source frame rate of the first video frame and the second video frame.

15. A system comprising:
a spatial light modulator (SLM); and
a display controller including:
a video input,
an SLM control output coupled to an input of the SLM, and
a variable refresh rate circuit configured to:
receive, via the video input, a first video frame;
instruct, via the SLM control output, the SLM to display a first dithered segment of the first video frame during reception of a second video frame; and
responsive to reception of the second video frame and completion of display of the first dithered segment, instruct, via the SLM control output, the SLM to display a second dithered segment of the second video frame.

16. The system of claim 15, wherein:
the display controller includes a buffer configured to store the second video frame; and
the variable refresh rate circuit is configured to instruct the SLM to display the second dithered segment responsive to completion of storage of the second video frame in the buffer.

17. The system of claim 15, wherein:
the display controller includes a buffer subdivided into a plurality of sub-buffers configured to store the second video frame; and
the variable refresh rate circuit is configured to instruct the SLM to display the second dithered segment responsive to completion of storage of a portion the second video frame in one of the sub-buffers.

18. The system of claim 15, wherein the variable refresh rate circuit is configured to adjust a display frame rate based on a time between reception of the first video frame and reception of the second video frame, or provide a display frame rate that is different from a source frame rate of the first video frame and the second video frame.

19. The system of claim 15, wherein:
the display controller is configured to instruct the SLM to display the first video frame as first, second, and third color segments; and
the variable refresh rate circuit is configured to instruct the SLM to display the color segments until reception of the second video frame.

20. The system of claim 19, wherein:
the color segments include multiple dithered segments; and
the variable refresh rate circuit is configured to instruct the SLM to display the second dithered segment of the second video frame responsive to completion of display of one of the color segments or completion of display of the first video frame.
